(19) United States
(12) Patent Application Publication
(10) Pub. No.: US 2006/0055788 A1
(43) Pub. Date: Mar. 16, 2006

(54) Image capturing apparatus, and method of setting flash synchronization speed

(75) Inventor: Koutaro Kawabe, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/101,896

(22) Filed: Apr. 8, 2005

(30) Foreign Application Priority Data
Sep. 14, 2004 (JP) JP2004-266799

(51) Int. Cl. H04N 5/228

(52) U.S. Cl. 348/208.12

(57) ABSTRACT

An image capturing technique capable of extending a settable range of exposure conditions and achieving appropriate image capturing in accordance with a subject is provided. In response to an operation of a mode setting dial included in an operation unit, a selection is made between a camera-shake compensation ON mode for achieving camera-shake compensation and a camera-shake compensation OFF mode for not achieving camera-shake compensation, under the control of an overall control section. Then, a flash synchronization speed is set higher in the camera-shake compensation ON mode than in the camera-shake compensation OFF mode.

This application is based on application No. 2004-266799 filed in Japan, the contents of which are hereby incorporated by reference.

### BACKGROUND OF THE INVENTION

1. Field of the Invention

The present invention relates to an image capturing apparatus.

2. Description of the Background Art

An image capturing apparatus such as a single lens reflex camera employs a mechanism such as a focal plane shutter for controlling exposure time.

In the case of flash shooting with an image capturing apparatus employing such a mechanical shutter, the lowest limit of a shutter speed (called a “flash synchronization speed”) is to be determined depending on an operating speed of the mechanical shutter in order to make uniform exposure on the whole of an area to be exposed (hereinafter referred to as an “exposure area”) in which an imaging device, a film and the like are placed. In other words, the flash must be fired with the whole exposure area being uniformly illuminated with light reflected from a subject.

To reduce influences exerted by camera shake, a technique for detecting camera shake using a gyroscope or the like and shifting an imaging device vertically and horizontally in accordance with camera shake, thereby capturing a clear image (hereinafter referred to as a “camera-shake compensation technology”) has been proposed (Japanese Patent Application Laid-Open No. 2004-056581). Since an exposure area is large in such construction that the imaging device is shifted vertically and horizontally, the flash synchronization speed needs to be reduced.

The necessity to reduce the flash synchronization speed will now be discussed in reference to FIGS. 12 and 13.

FIGS. 12 and 13 are explanatory views each illustrating a flash synchronization speed. Illustration is made with respect to the case of using an image capturing apparatus provided with a focal plane shutter having a front curtain (first curtain) extending downwardly from the upper side and a rear curtain (second curtain) extending upwardly from the lower side. FIGS. 12 and 13 each plot time (t) on the horizontal axis and show timing charts of various control signals, flash emission state and shutter operations in descending order. The distributions of the amount of exposure are shown on the right side of the timing chart of shutter operations. More specifically, the timing charts of a front-curtain driving start signal (1cMg), a rear-curtain driving start signal (2cMg), flash emission start signal (XSW) and flash emission state (FLASH) are shown in descending order. Shown below these timing charts is the timing chart of changes in positional relationship of the front and rear curtains with respect to the exposure area in the vertical direction, that is, the timing chart of shutter operations.

When the front-curtain driving start signal (1cMg), rear-curtain driving start signal (2cMg) and flash emission start signal (XSW) are changed from “H” (high) to “L” (low) state, the driving of the front curtain, the driving of the rear curtain and the flash emission are started, respectively. Referring to the flash emission state (FLASH), part of the waveform that projects upwardly corresponds to the flash intensity. Referring to the changes in positional relationship of the front and rear curtains with respect to the exposure area, the upper end and lower end of an area in which the imaging device can be shifted (i.e., the exposure area) are indicated by Hmax and Lmax, respectively, and changes in position of the lower end of the front curtain and upper end of the rear curtain are shown by solid lines 1C and 2C, respectively. Further, the distributions of the amount of exposure when the image capturing apparatus is driven in response to the signals and timing of operations shown in FIGS. 12 and 13 are illustrated for each of regions (upper end region PU, central region PC and lower end region PD) occupied by an image capturing surface of the imaging device assumed to be placed at the highest possible position, the center and the lowest possible position in the exposure area, respectively (that is, the distributions are shown lighter as the amount of exposure increases and darker as the amount of exposure decreases).

FIG. 12 illustrates the case of a relatively low shutter speed, while FIG. 13 illustrates the case of a relatively high shutter speed.

As shown in FIG. 12, according to a conventional technique, the driving of the front curtain is started (at time t101), and the lower end of the front curtain reaches the upper end Hmax of the exposure area (at time t102). Then, a state is brought about in which exposure can be made on the whole exposure area, that is, the focal plane shutter is fully opened (also referred to as a “shutter-open state”). At this time, the front curtain mechanically works on a predetermined mechanical switch to bring the mechanical switch into an ON state. In other words, a signal for starting flash emission (flash emission start signal XSW) is brought into an L state, in which flash emission is started. After a lapse of a sufficient period from the end of flash emission (at time t103), the driving of the rear curtain is started (at time t104), and the upper end of the rear curtain reaches the upper end Hmax of the exposure area, at which time exposure is completed (at time t105).

As described, in the case of a relatively low shutter speed, a flash emission period is included in the period of the shutter-open state. Therefore, the exposure area is uniformly illuminated with light reflected from a subject. For instance, as shown on the right side of FIG. 12, uniform illumination of light reflected from the subject uniformly increases the distribution of the amount of exposure, regardless of the position in the vertical direction of each region occupied by the image capturing surface.

On the other hand, as shown in FIG. 13, the driving of the front curtain is started (at time t111), and the driving of the rear curtain is started (at time t112) before the lower end of the front curtain reaches the upper end Hmax. Thereafter, at the time when the lower end of the front curtain reaches the upper end Hmax, the front curtain mechanically works on the predetermined mechanical switch, so that flash emission is started (at time t113). Then, flash emission is completed (at time t114), and finally, the upper end of the rear curtain reaches the upper end Hmax, at which time exposure is completed (at time t115).

As described, in the case of a relatively high shutter speed, the driving of the rear curtain is started before flash emission is started. Accordingly, light reflected from the subject is partly blocked by the rear curtain during flash emission, causing part of the exposure area to be insufficiently exposed. For instance, as shown on the right side of FIG. 13, the amount of exposure is uniformly high in the region PU occupied by the image capturing surface when placed on the upper end of the exposure area. In the region PC occupied by the image capturing surface when placed at the center of the exposure area, however, the amount of exposure is high in the upper portion but low in the lower portion. In the region PD occupied by the image capturing surface when placed on the lower end of the exposure area, the amount of exposure is low on almost the whole image capturing surface.

As described, setting the shutter speed high results in a nonuniform amount of exposure on the exposure area.

Accordingly, the image capturing apparatus employing the above-described camera-shake compensation technology needs to keep the shutter open during flash emission in order to make uniform exposure on the whole area in which the imaging device can be shifted (i.e., the exposure area). Therefore, the lowest limit of the shutter speed (flash synchronization speed) needs to be set relatively low.

In the image capturing apparatus employing the above-described camera-shake compensation technology, however, a predetermined flash synchronization speed limits a settable range of exposure conditions. In other words, setting of more preferable shooting conditions in accordance with a subject is limited.

Such a problem is encountered not only in the image capturing apparatus employing the camera-shake compensation technology of shifting an imaging device but also in an image capturing apparatus employing a camera-shake compensation technology of shifting a section for guiding light from a subject and a section on which the light forms an image (i.e., light image) and the like such as a technique of shifting a taking lens device vertically and horizontally and changing its angle.

### SUMMARY OF THE INVENTION

The present invention is directed to an image capturing apparatus.

According to an aspect of the present invention, the image capturing apparatus includes: a taking lens device for forming a light image of a subject on a predetermined image capturing surface; a light emitter for emitting light in flash shooting; a camera-shake compensation part for suppressing a relative displacement between the image capturing surface and the light image caused by camera shake, thereby achieving camera-shake compensation; a mode setting part for selecting between a first mode in which the camera-shake compensation part is activated and a second mode in which the camera-shake compensation part is deactivated; and a changing part for changing a flash synchronization speed in accordance with a selection made by the mode setting part.

For instance, the flash synchronization speed can be changed so as to be relatively higher in the second mode for not achieving camera-shake compensation than in the first mode for achieving camera-shake compensation. This extends a settable range of exposure conditions in the second mode, making it possible to achieve appropriate image capturing in accordance with the subject.

According to another aspect of the present invention, the image capturing apparatus includes: a taking lens device for forming a light image of a subject on a predetermined image capturing surface; a light emitter for emitting light in flash shooting; a camera-shake compensation part for suppressing a relative displacement between the image capturing surface and the light image caused by camera shake, thereby achieving camera-shake compensation; and a mode setting part for selecting between a first mode in which the camera-shake compensation part is activated and a second mode in which the camera-shake compensation part is deactivated. A flash synchronization speed is set higher in the second mode than in the first mode.

Since a settable range of exposure conditions in the second mode is extended, it is possible to achieve appropriate image capturing in accordance with the subject.

The present invention is also directed to a method of setting a flash synchronization speed in an image capturing apparatus.

It is therefore an object of the present invention to provide an image capturing technique capable of extending a settable range of exposure conditions and achieving appropriate image capturing in accordance with a subject.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B each illustrate an external construction of an image capturing apparatus according to a first preferred embodiment of the present invention;

FIGS. 2A and 2B each illustrate an internal construction of the image capturing apparatus according to the first preferred embodiment;

FIG. 3 is a side sectional view of a construction of a focal plane shutter;

FIG. 4 illustrates an image circle and an image obtaining region on an image forming plane;

FIG. 5 is a disassembled perspective view of a CCD shifting section;

FIG. 6 is a block diagram of a functional construction of the image capturing apparatus according to the first preferred embodiment;

FIG. 7 shows timing charts of an image capturing operation according to the first preferred embodiment;

FIG. 8 is an explanatory view of a flash synchronization speed in a camera-shake compensation ON mode;

FIG. 9 is an explanatory view of a flash synchronization speed in a camera-shake compensation OFF mode;

FIG. 10 is a flow chart of a changing operation of a flash synchronization speed according to the first preferred embodiment;

FIG. 11 is an explanatory view of a flash synchronization speed according to a second preferred embodiment of the invention; and

FIGS. 12 and 13 are explanatory views of a flash synchronization speed.

### DESCRIPTION OF THE PREFERRED EMBODIMENTS

Preferred embodiments of the present invention will be discussed with reference to the accompanying drawings.

### First Preferred Embodiment

Outline of Image Capturing Apparatus

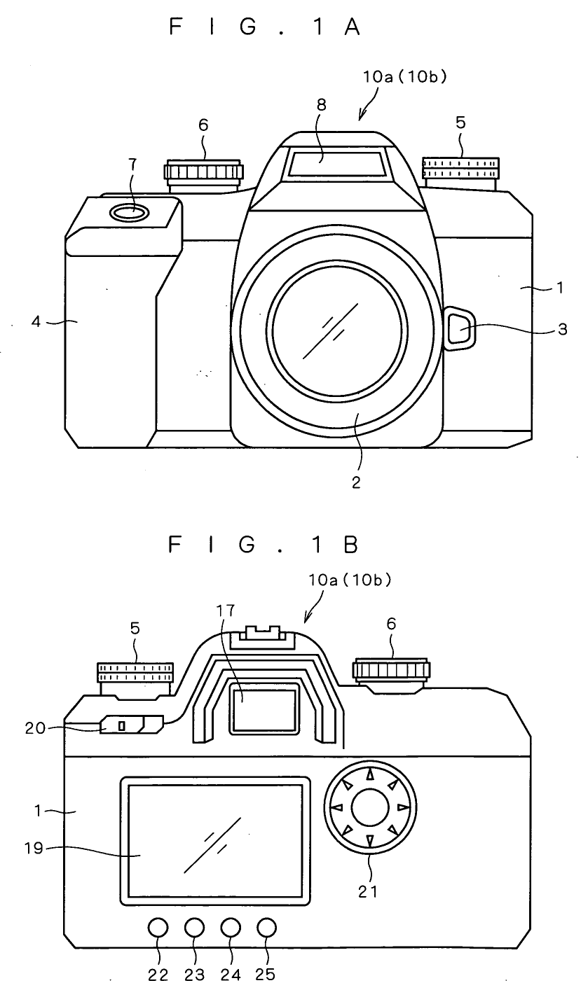

FIGS. 1A and 1B each illustrate an external construction of an image capturing apparatus 10a according to a first preferred embodiment of the present invention. FIG. 1A is an external front view, and FIG. 1B is an external rear view.

As shown in FIG. 1A, the image capturing apparatus 10a according to the present embodiment is constructed from a single lens reflex digital camera including a camera body 1 and an interchangeable lens device (corresponding to a taking lens device) 2 detachably attached almost at the center of the front face of the camera body 1.

In FIG. 1A, the camera body 1 is provided with a mounting part (not shown) near almost the center of its front face to which the interchangeable lens device 2 is mounted, an attaching/detaching button 3 near the mounting part for attaching/detaching the interchangeable lens device 2, a grip 4 on the left side on its front face to be held by a user, a control-value setting dial 5 on the right side on its front face for setting a control value, a mode setting dial (corresponding to a shooting-mode changing part) 6 on the left side on its front face for changing shooting modes, a release button 7 on the top side of the grip 4 for instructing the start and/or end of exposure, and a built-in flash 8 emitting light for illuminating a subject in flash shooting. Provided near the mounting part are a plurality of electrical contacts (not shown) for establishing electric connection with the interchangeable lens device 2 as mounted and a plurality of couplers (not shown) for establishing mechanical connections with the interchangeable lens device 2.

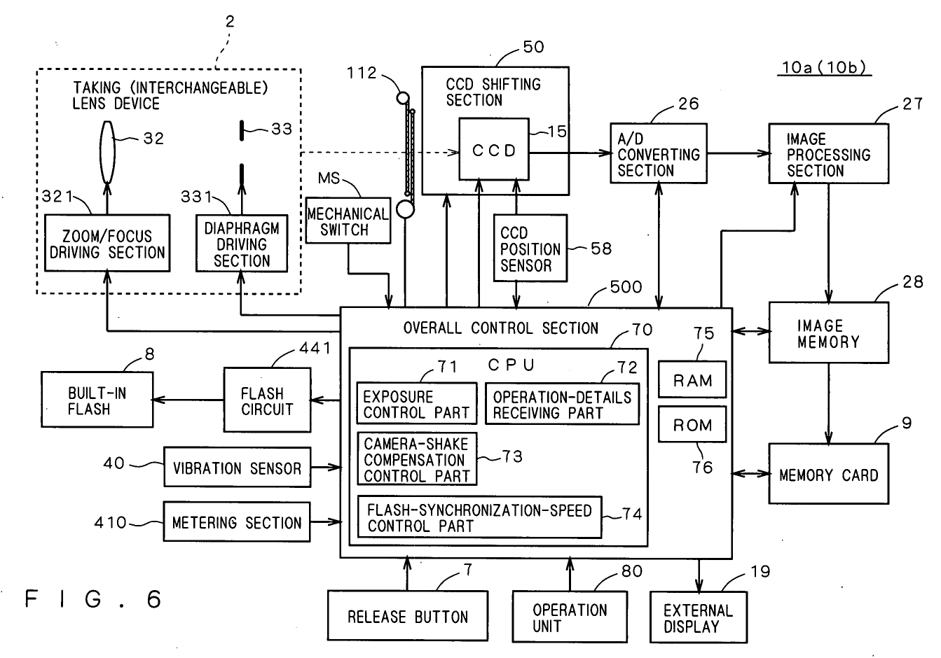

The electrical contacts are intended to transmit information specific to the interchangeable lens device 2 (e.g., F-number and focal length) from a lens ROM (read-only-memory) built in the interchangeable lens device 2 and information about the positions of a focusing lens element and a zoom lens element in the interchangeable lens device 2, to an overall control section 500 (which will be described later; see FIG. 6) in the camera body 1.

The plurality of couplers are intended to convey the driving force of a motor for driving the focusing lens element and that of a motor for driving the zoom lens element, both motors being provided in the camera body 1, to the focusing lens element and zoom lens element in the interchangeable lens device 2, respectively.

In FIG. 1A, a battery chamber and a card slot are provided inside the grip 4. For instance, four AA batteries are removably inserted in the battery chamber to serve as a power source for the camera, and the card slot is designed to removably accept a memory card 9 (see FIG. 6) for recording image data of captured images thereon.

The mode setting dial 6 is intended to select among a plurality of shooting modes including a still image capturing mode for capturing a still image and a motion image capturing mode for capturing a motion image. Here, the still image capturing mode includes a still image capturing mode for achieving camera-shake compensation which will be discussed later (hereinafter referred to as a “camera-shake compensation ON mode”) and a still image capturing mode for not achieving camera-shake compensation (hereinafter referred to as a “camera-shake compensation OFF mode”). The mode setting dial 6 is rotated as required to turn camera-shake compensation on and off.

The release button 7 is constructed to be able to create a “half-pressed state S1” in which the release button 7 is pressed partway and a “full-pressed state S2” in which the release button 7 is pressed further. In the still image capturing mode, when the release button 7 is half-pressed, preparatory operations for capturing a still image of a subject (e.g., exposure control value setting and focal point adjustment) are executed, and when the release button 7 is full-pressed, an image capturing operation (a series of steps of exposing a color imaging device which will be described later, performing predetermined image processing on an image signal obtained by the exposure and recording the image signal as processed into a memory card) is executed. In the motion image capturing mode, when the release button 7 is full-pressed, an image capturing operation (a series of steps of exposing a color imaging device, performing predetermined image processing on an image signal obtained by the exposure and recording the image signal as processed into a memory card) is started, and when the release button 7 is full-pressed again, the image capturing operation is finished.

In FIG. 1B, a viewfinder 17 is provided almost in the central upper position on the rear face of the camera body 1. An image of the subject is guided from the interchangeable lens device 2 to the viewfinder 17. A user can visually identify the subject looking at the viewfinder 17.

An external display (LCD monitor) 19 is provided almost at the center of the rear face of the camera body 1. In the present embodiment, the external display 19 is constructed from a color liquid crystal display having 400 (X direction)×300 (Y direction) pixels=120,000 pixels, for example, and is intended to display, in a recording mode, a menu screen for setting a mode relative to exposure control, a mode relative to a scene to be shot, shooting conditions and the like, and is intended to play back, in a playback mode, a captured image recorded into a memory card.

A power switch 20 is provided on the upper left side of the external display 19, and is constructed from a two-position slide switch. A flick of the switch to an “OFF” position on the left side turns the power off, and a flick of the switch to an “ON” position on the right side turns the power on.

A direction-selection key 21 is provided on the right side of the external display 19, and has a circular control button. Pressing on the control button in four directions: upward; downward; rightward; and leftward, and pressing in four directions: upward to the right; upward to the left; downward to the right; and downward to the left are detected respectively.

The direction-selection key 21 is provided with versatility, and serves as, for example, a control switch for changing an item selected on the menu screen displayed on the external display 19 for setting a scene to be shot and a control switch for changing a frame to be played back selected on an index screen on which a plurality of thumbnail images are arranged. Additionally, the direction-selection key 21 may also serve as a zoom switch for changing the focal length of the zoom lens element of the interchangeable lens device 2.

Below the external display 19, a cancel switch 22, an accept switch 23, a menu-display switch 24 and an external-display switch 25 are provided for performing operations relative to the display of the external display 19 and information displayed thereon.

The cancel switch 22 is a switch for canceling a selection made on the menu screen. The accept switch 23 is a switch for accepting a selection made on the menu screen. The menu-display switch 24 is a switch for displaying the menu screen on the external display 19 and changing the contents of the menu screen (e.g., a shooting scene setting screen and a mode setting screen relative to exposure control). The contents of the menu screen are changed each time the menu-display switch 24 is pressed. The external-display switch 25 is a switch for turning the external display 19 on and off. The external display 19 is turned on and off alternately each time the external-display switch 25 is pressed. For battery saving, the external display 19 may be controlled so as not to be turned on at startup of the camera.

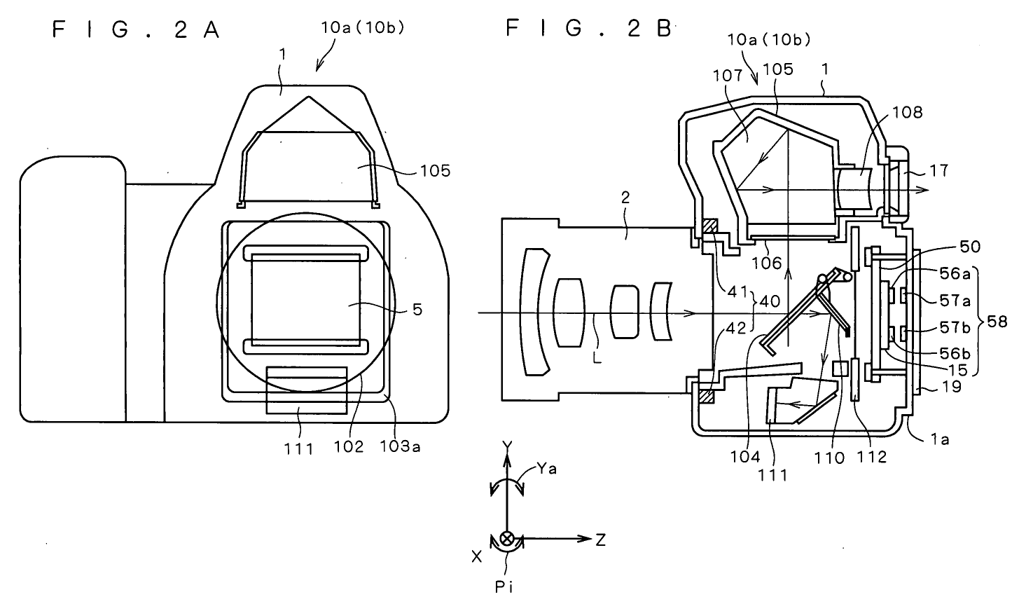

Next, the internal construction of the image capturing apparatus 10a according to the first preferred embodiment of the present invention will be described. FIGS. 2A and 2B each illustrate an internal construction of the image capturing apparatus 10a according to the first preferred embodiment. FIG. 2A is a front view, and FIG. 2B is a side sectional view.

As shown in FIGS. 2A and 2B, the image capturing apparatus 10a mainly includes the camera body 1 and the interchangeable lens device (taking lens device) 2 detachably mounted almost at the center of the front face of the camera body 1. As shown in FIG. 2B, a color imaging device (e.g., a CCD imaging device with R, G and B pixels arranged in Bayer pattern; hereinafter abbreviated to “CCD”) 15 is provided in an appropriate position in the camera body 1 on an optical axis L of the interchangeable lens device 2 when attached to the camera body 1.

On the optical axis L, a half mirror 104 is provided in a position where light reflected from a subject is reflected off to change its direction toward a finder optical system 105. Light reflected from the subject as reflected off the half mirror 104 is focused on a focusing plate 106. The finder optical system 105 includes a pentagonal prism 107, an eyepiece 108 and the viewfinder 17. An image of the subject formed on the focusing plate 106 is reflected off the pentagonal prism 107 to enter the eyepiece 108. The eyepiece 108 guides the image of the subject to the outside of the viewfinder 17. With such arrangement, a user can visually recognize the subject looking at the viewfinder 17.

Provided behind the half mirror 104 is a sub-mirror 110 for reflecting light reflected from the subject as transmitted through the half mirror 104, and light reflected off the sub-mirror 110 enters a focus detecting section 111. The focus detecting section 111 detects focal information of the subject.

The half mirror 104 and sub-mirror 110 are so-called quick return mirrors, which spring up at the time of exposure to guide the light reflected from the subject onto the CCD 15, and return to their original positions when exposure is finished. In other words, light reflected from the subject guided by the interchangeable lens device 2 forms an image on a light-receiving surface (also referred to as an “image capturing surface”) of the CCD 15 with the half mirror 104 and sub-mirror 110 placed in the up position.

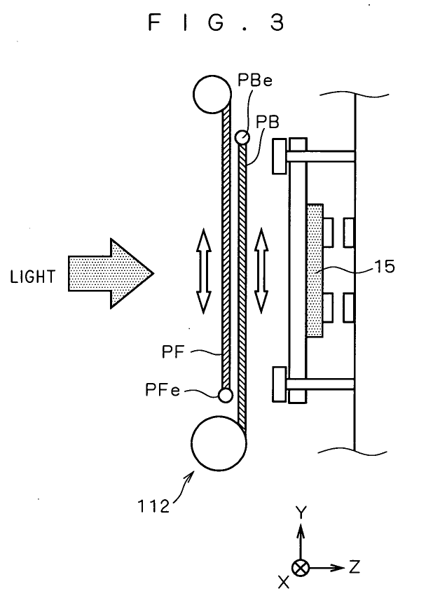

A shutter 112 is provided just in front of the CCD 15, and is controlled so as to open and close at the time of exposure. This shutter 112 is intended to open and block an optical path for guiding light reflected from the subject to the image capturing surface of the CCD 15, and a focal plane shutter is employed here. FIG. 3 is a side sectional view of the mechanism of the shutter 112 and the surrounding construction. As shown in FIG. 3, this focal plane shutter has a roll-up front curtain (first curtain) PF extending downwardly (in −Y direction) and a roll-up rear curtain (second curtain) PB extending upwardly (in +Y direction). In short, the front curtain PF and rear curtain PB can be driven vertically (in ±Y directions).

For instance, with an end (upper end) PBe of the rear curtain PB moved to reach the lower end of a movable range (i.e., with the rear curtain PB retracted from the optical path from the subject to the CCD 15; hereinafter also referred to as a “retracted state”), an end (lower end) PFe of the front curtain PF is moved from the lower end of a movable range (a state inserted into the optical path; hereinafter also referred to as an “inserted state”) to reach the upper end of the movable range (a retracted state), so that the shutter 112 is open. Further, the end PBe of the rear curtain PB in the above state is moved to reach the upper end of the movable range (i.e., brought into an inserted state), so that the shutter 112 is closed. The shutter speed is adjusted by controlling such timing of driving the front curtain PF and rear curtain PB.

The image capturing apparatus 10a has a camera-shake compensation function of compensating for (or reducing) subject blur in a captured image due to camera shake. This camera-shake compensation function is achieved by shifting the CCD 15 relative to the image capturing apparatus 10a in accordance with camera shake detected by a vibration sensor 40 which will be described later.

Now, a CCD shifting section 50 including the CCD 15 for shifting the CCD 15 and associated surrounding sections will be described. In the following description, the direction and orientation are indicated using an XYZ three-dimensional orthogonal coordinate system shown in the drawing as necessary. Here, the Z axis extends along the optical axis L of the interchangeable lens device 2, and the positive direction of the Z axis is a direction in which light is incident (the rightward direction in the drawing). The Y axis extends in the vertical direction, and the positive direction of the Y axis is a vertically upward direction (the upward direction in the drawing). The X axis extends in a direction normal to the sheet of drawing, and the positive direction of the X axis is a downward direction normal to the sheet of drawing. These X, Y and Z axes are determined relative to a housing 1a of the camera body 1.

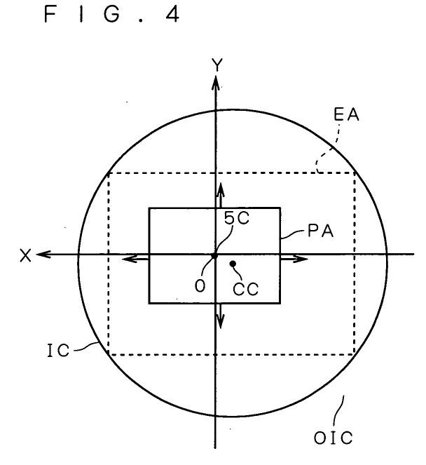

The interchangeable lens device 2 mainly includes a lens barrel, a lens group of a plurality of lens elements provided inside the lens barrel and a diaphragm. The interchangeable lens device 2 is configured to serve as a zoom lens device whose focal length (magnification ratio) is variable by changing the arrangement of the lens group in the Z direction. The light image of the subject formed by the interchangeable lens device 2 forms an approximately circular shape on an X-Y plane where an image is formed (hereinafter referred to as an “image forming plane”), as shown in FIG. 4, which is called an image circle IC. The CCD 15 housed in the housing 1a of the camera body 1 is arranged in the rear direction of the optical axis L of the interchangeable lens device 2 (in the positive direction of the Z axis).

The light-receiving surface (image capturing surface) of the CCD 15 is arranged to correspond to the image forming plane, and part of the image forming plane including the image circle IC is obtained as image data (also briefly referred to as an “image” as necessary throughout the present specification). In FIG. 4, a rectangular area PA indicates an exemplary arrangement of an effective pixel group of the CCD 15 on the image forming plane. This area is obtained as an image on the image forming plane, and is accordingly called an “image obtaining area” PA as well. An area OIC outside the image circle IC on the image forming plane may also be obtained as an image. In that case, however, a reduction in the amount of light called “vignette” occurs in an area in the image that corresponds to the area OIC.

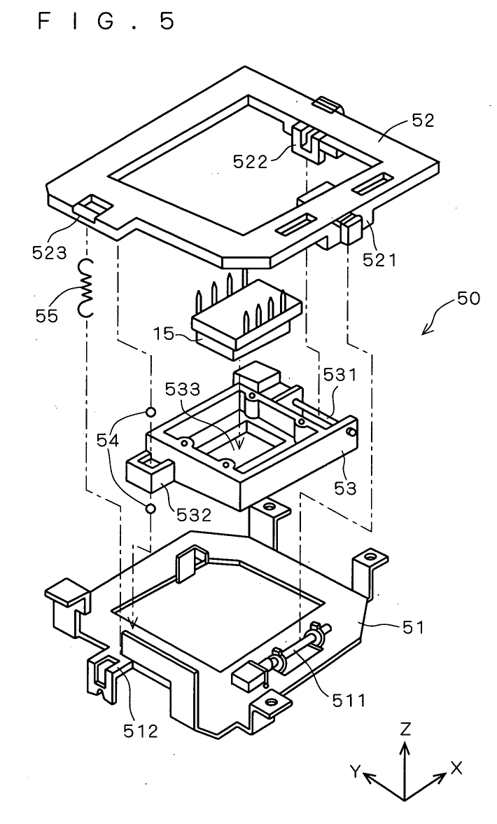

The CCD 15 is provided fixedly inside the CCD shifting section 50. The CCD 15 can be shifted on the X-Y plane orthogonal to the Z axis by the CCD shifting section 50. FIG. 5 is a disassembled perspective view of the CCD shifting section 50 including the CCD 15.

As shown in FIG. 5, the CCD shifting section 50 mainly includes a base plate 51 fixed to the housing 1a, a first slider 52 moving along the X axis with respect to the base plate 51 and a second slider 53 moving along the Y axis with respect to the first slider 52.

The base plate 51 has an opening at its center for passing therethrough light incident from the interchangeable lens device 2, and is provided with a first actuator 511 extending along the X axis and a first spring hook 512 on which a spring 55 is hooked. The second slider 53 has an opening 533 at its center where the CCD 15 can be fixed, and is provided with a second actuator 531 extending along the Y axis and a rigid-ball holder 532 for freely holding a rigid ball 54 on each side thereof along the Z axis. The first slider 52 has an opening at its center, and is provided with a first frictional-connection portion 521 arranged to face the first actuator 511, a second frictional-connection portion 522 arranged to face the second actuator 531, and a second spring hook 523 arranged to face the first spring hook 512.

Each of the first actuator 511 and second actuator 531 has a piezoelectric device and a driving rod movable in the lengthwise direction. The driving rod moves in an amount and a direction in accordance with a driving pulse applied to the piezoelectric device.

When assembling the CCD shifting section 50, the CCD 15 is arranged to fit into the opening 533 of the second slider 53, while the driving rod of the first actuator 511 and the first frictional-connection portion 521 are connected by friction, and the driving rod of the second actuator 531 and the second frictional-connection portion 522 are connected by friction. The base plate 51 and first slider 52 are urged to get closer to each other by the spring 55. In this state, the second slider 53 is sandwiched between the base plate 51 and first slider 52 with rigid balls 54 interposed therebetween. Accordingly, the base plate 51, second slider 53 and first slider 52 are arranged on one another in this order from the negative direction to the positive direction of the Z axis.

When the driving rod of the first actuator 511 moves at low speeds with the CCD shifting section 50 assembled as described above, the first slider 52 moves along the X axis with respect to the base plate 51 by the first frictional-connection portion 521 connected to the first actuator 511 by friction. At this time, the second slider 53 also moves along the X axis with respect to the base plate 51 with the movement of the first slider 52. When the driving rod of the first actuator 511 moves at high speeds, the first slider 52 stops by an inertial force. When the moving rod of the second actuator 531 moves at low speeds, the second slider 53 moves along the Y axis with respect to the first slider 52 by the second frictional-connection portion 522 connected to the second actuator 531 by friction. At this time, the first slider 52 does not move with respect to the base plate 51, which means the second slider 53 moves alone along the Y axis with respect to the base plate 51. When the driving rod of the second actuator 531 moves at high speeds, the second slider 53 stops by an inertial force. That is, the respective driving rods move to and fro (i.e., vibrate) at different speeds to each other in accordance with driving pulses applied to the respective piezoelectric devices, so that the second slider 53 moves along the X and Y axes.

Further, as described above, the base plate 51 is fixed to the housing 1a of the camera body 1, and the CCD 15 is fixed to the second slider 53. Accordingly, the CCD 15 is shifted relative to the housing 1a of the camera body 1 on the X-Y plane. Therefore, it is possible to shift the CCD 15 relative to the image circle IC formed by the interchangeable lens device 2, allowing an area obtained as an image in the image circle IC to be changed. Here, in FIG. 4, assuming that the area obtained as an image is to be changed in a rectangular area EA surrounded by dotted lines in the image circle IC, this area EA can also be considered as an area necessary to be exposed on the image forming plane (hereinafter also referred to as an “exposure area”) in the camera-shake compensation ON mode.

Such a position of the CCD 15 that a central position (hereinafter referred to as an “image central position”) 5C of the effective pixel group (image obtaining area PA) of the CCD 15 agrees with a central position CC of the image circle IC is recorded on a ROM 76 which will be described later.

Referring back to FIG. 2, a CCD position sensor 58 for detecting the position of the CCD 15 being shifted is provided in the positive direction of the Z axis with respect to the CCD 15. The CCD position sensor 58 has first and second light projecting sections 56a and 56b constructed from light-emitting diodes or the like and first and second light receiving sections 57a and 57b constructed from photodiodes or the like. The light projecting sections 56a and 56b are fixed to the rear side of the CCD 15 (in the positive direction of the Z axis), while the light receiving sections 57a and 57b are fixed to the housing 1a of the camera body 1 so as to face the light projecting sections 56a and 56b, respectively. The light receiving sections 57a and 57b are capable of receiving light projected from the light projecting sections 56a and 56b, respectively. X and Y coordinates of the position of the CCD 15 is obtained according to changes in position of light received by the light receiving sections 57a and 57b. More specifically, the first light projecting section 56a and first light receiving section 57a are intended to detect the position of the CCD 15 along the X axis, and the second light projecting section 56b and second light receiving section 57b are intended to detect the position of the CCD 15 along the Y axis.

Further, the vibration sensor 40 for detecting a vibration caused by a shake of the image capturing apparatus 10a is provided inside the housing 1a of the camera body 1. The vibration sensor 40 has two angular velocity sensors (first angular velocity sensor 41 and second angular velocity sensor 42). The first angular velocity sensor 41 detects an angular velocity of rotation vibration (pitching) Pi about the X axis, and the second angular velocity sensor 42 detects an angular velocity of rotation vibration (yawing) Ya about the Y axis. The CCD 15 is shifted along the X and Y axes, respectively, based on the two angular velocities detected by the vibration sensors 40, so that compensation for subject blur in a captured image, that is, camera-shake compensation is achieved.

As described, a vibration caused by camera shake creates a relative displacement between the light image of the subject (the image of the subject) and the image capturing surface of the CCD 15 on which the image of the subject is formed. Then, the position of the image capturing surface is changed relative to the housing 1a in response to the two angular velocities detected by the vibration sensor 40 in accordance with the vibration caused by camera shake. Accordingly, camera-shake compensation of reducing a relative displacement between the image capturing surface and the image of the subject is executed. Camera-shake compensation can thereby be achieved easily.

The camera-shake compensation function and other various functions of the image capturing apparatus 10a including a flash-synchronization-speed changing function which will be described later and the like are achieved under the control of an overall control section 500 provided in the housing 1a of the camera body 1. FIG. 6 is a functional block diagram of a principle functional construction of the image capturing apparatus 10a including the overall control section 500.

As shown in FIG. 6, respective processing sections of the image capturing apparatus 10a such as the CCD 15, the CCD shifting section 50, the CCD position sensor 58, the vibration sensor 40, the release button 7, an operation unit 80, the external display 19 and a flash circuit 441 are electrically connected to the overall control section 500, and are operated under the control of the overall control section 500. In parallel with this, the position of the CCD 15 detected by the CCD position sensor 58, the angular velocities detected by the vibration sensor 40, the result of operation of the release button 7, the result of operation of the operation unit 80 and the like are respectively input to the overall control section 500 as signals.

The interchangeable lens device 2 includes a zoom/focus driving section 321 and a diaphragm driving section 331. The zoom/focus driving section 321 is intended to move lens elements included in a (focusing) lens group 32 along the Z axis as necessary so as to provide a focal length set by a user and so as to obtain focus. The diaphragm driving section 331 is intended to adjust the aperture diameter of a diaphragm 33 so as to achieve a diaphragm value set by the overall control section 500. The zoom/focus driving section 321 and diaphragm driving section 331 are also electrically connected to the overall control section 500, and are operated under the control of the overall control section 500.

The shutter 112 is a focal plane shutter whose front curtain PF and rear curtain PB are driven as described above. In an image capturing operation, the end PFe of the front curtain PF of the shutter 112 is moved to reach the upper end of the movable range to bring the shutter 112 into an open state. At this time, the front curtain PF works on a mechanical switch MS which is mechanically driven, so that the switch MS transmits a signal to the overall control section 500. In flash shooting, the overall control section 500 causes the built-in flash 8 to emit light through the flash circuit 441 in response to the signal transmitted from the mechanical switch MS.

Further, in FIG. 6, an A/D converting section 26, an image processing section 27 and an image memory 28 are processing sections for processing an image obtained by the CCD 15. More specifically, an analog signal of an image obtained by the CCD 15 is converted to a digital signal at the A/D converting section 26, subjected to predetermined image processing at the image processing section 27, and then stored in the image memory 28. The image stored in the image memory 28 is recorded in the memory card 9 as an image to be recorded. Such various kinds of processing on an image are also conducted under the control of the overall control section 500.

The flash circuit 441 is intended to control flash emission from the built-in flash 8. In response to a signal from the overall control section 500, the flash circuit 441 adjusts flash emission timing and flash emission period (the amount of flash emission) of the built-in flash 8.

A metering section 410 is provided, for example, near the CCD 15 and is intended to receive light incident upon the CCD 15 through the interchangeable lens device 2 to detect the brightness of the subject. A signal indicative of the brightness of the subject (brightness information) detected by the metering section 410 is transmitted to the overall control section 500.

The operation unit 80 includes the switches 22 to 25, the control-value setting dial 5 and the mode setting dial 6.

The overall control section 500 is configured to include a microcomputer. More specifically, the overall control section 500 includes a CPU 70 for performing various arithmetic operations, a RAM 75 serving as an operation area for arithmetic operations and the ROM 76 in which a control program and the like are recorded, and is intended to exercise control over the above-described operations of the respective processing sections of the image capturing apparatus 10a. An EEPROM additionally programmable with data is employed as the ROM 76. Therefore, the ROM 76 is additionally programmable with data and maintains the contents of stored data during power-down.

Various functions of the overall control section 500 are achieved by arithmetic operations performed by the CPU 70 in accordance with the control program previously recorded in the ROM 76. In FIG. 6, an exposure control part 71, an operation-details receiving part 72, a camera-shake compensation control part 73 and a flash-synchronization-speed control part 74 schematically show part of functions achieved by arithmetic operations performed by the CPU 70 in accordance with the control program.

The exposure control part 71 is intended to perform exposure control of setting a shutter speed and an aperture value. More specifically, the exposure control part 71 determines an exposure value based on the brightness information of the subject transmitted from the metering section 410, and further, sets a shutter speed and an aperture value based on the determined exposure value. The exposure control part 71 is capable of determining whether or not to cause the built-in flash 8 to emit light based on the brightness information of the subject, and further, capable of setting the amount of flash emission (that is, flash emission period). For flash shooting by means of flash emission from the built-in flash 8, a shutter speed and the like are set in accordance with a flash synchronization speed which will be described later. In the image capturing apparatus 10a, the shutter speed corresponds to the exposure time (integration time) of the CCD 15.

The operation-details receiving part 72 receives a signal indicative of the details of operations made by the release button 7 and operation unit 80 (e.g., setting of the focal length of the interchangeable lens device 2). The details of operations are recorded in the RAM 75 and are input to the respective processing sections. The respective processing sections of the image capturing apparatus 10a operate in accordance with the operations.

The camera-shake compensation control part 73 exercises control for the camera-shake compensation function. More specifically, the camera-shake compensation control part 73 derives a position to which the CCD 15 is to be shifted (hereinafter referred to as a “destination position”) that corresponds to the amount and direction of blur of the image of the subject caused by camera shake based on the two angular velocities supplied from the vibration sensor 40. A destination position is determined such that the image obtaining area PA (see FIG. 4) is always placed in the exposure area EA in order to avoid the occurrence of vignette in a captured image.

Further, the camera-shake compensation control part 73 compares the current position of the CCD 15 obtained by the CCD position sensor 58 with the derived destination position to derive the amount of travel and direction in which the CCD 15 is to be shifted. Then, the camera-shake compensation control part 73 generates a driving pulse depending on the derived amount of travel and direction of shift, and transmits the driving pulse to the actuators 511 and 531 of the CCD shifting section 50, thereby shifting the CCD 15 to the destination position. In this manner, closed loop control is performed in which a destination position is derived in accordance with a vibration of the image capturing apparatus 10a and the current position of the CCD 15 is compared with the derived destination position, so that the CCD 15 is shifted to the destination position in sequence. This compensates for subject blur in a captured image.

Furthermore, in response to a rotation of the mode setting dial 6 included in the operation unit 80, the function of the camera-shake compensation control part 73 is turned on or off. In other words, a selection can be made with the mode setting dial 6 between a mode in which the function of the camera-shake compensation control part 73 is activated (camera-shake compensation ON mode) and a mode in which the function of the camera-shake compensation control part 73 is inactivated (camera-shake compensation OFF mode).

When the camera-shake compensation ON mode is selected, the overall control section 500 exercises control to place the CCD 15 almost at the center of the movable range, i.e., the exposure area EA before the start of exposure such that the CCD 15 can be shifted with a certain lead time in either of upward, downward, rightward and leftward directions on the X-Y plane in accordance with camera shake. When the camera-shake compensation OFF mode is selected, the CCD 15 is not to be shifted. Thus, at the time of exposure, the overall control section 500 exercises control such that the CCD 15 having displaced due to a vibration or the like is shifted to almost the center of the exposure area EA and fixed thereto.

The flash-synchronization-speed control part 74 achieves a function of changing the lowest limit of a shutter speed (the so-called flash synchronization speed) in accordance with an operating speed of the shutter 112 in flash shooting (a flash-synchronization-speed changing function). More specifically, the flash-synchronization-speed control part 74 changes the settings of the flash synchronization speed so as to be relatively higher in the camera-shake compensation OFF mode than in the camera-shake compensation ON mode. Here, the flash synchronization speed as changed is temporarily stored in the RAM 75, and is used for exposure control at the exposure control part 71.

Image Capturing Operation

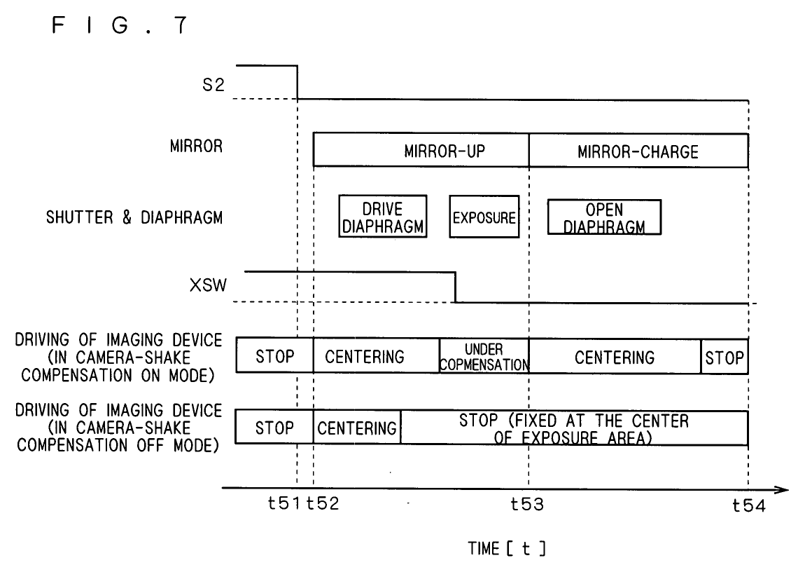

FIG. 7 shows timing charts of an image capturing operation of the image capturing apparatus 10a according to the first preferred embodiment. The timing charts of FIG. 7 plot time (t) on the horizontal axis and indicate, in descending order, the full-pressed state S2 of the release button 7, the driving of the half mirror 104, the driving of the shutter 112 and diaphragm 33, the flash emission start signal XSW, the driving of the CCD 15 in the camera-shake compensation ON mode and the driving of the CCD 15 in the camera-shake compensation OFF mode.

As shown in FIG. 7, when the release button 7 is brought into the full-pressed state S2 (at time t51), the half mirror 104 springs up (which is expressed as a mirror-up state) (from time t52 to time t53). In this mirror-up state, the CCD 15 is subjected to exposure while the built-in flash 8 emits light in response to the flash emission start signal XSW after the diaphragm 33 is driven in accordance with exposure control.

In the case where the camera-shake compensation ON mode is selected in this mirror-up state, centering for shifting the image capturing surface of the CCD 15 to almost the center of the exposure area EA is conducted before the start of exposure, and then, the camera-shake compensation is achieved in which the CCD 15 is shifted in response to detection of the angular velocities by the vibration sensor 40 from just before the start of exposure to the end of exposure. On the other hand, in the case where the camera-shake compensation OFF mode is selected, centering for shifting the image capturing surface of the CCD 15 to almost the center of the exposure area EA is conducted before the start of exposure, and the image capturing surface is fixed almost at the center of the exposure area EA.

After the end of exposure, the half mirror 104 returns from the mirror-up state to its original position (mirror-charge state). In this mirror-charge state, the diaphragm 33 is brought into a full-open state. Further, when the camera-shake compensation ON mode is selected, centering for shifting the image capturing surface of the CCD 15 to almost the center of the exposure area EA is conducted, and then the driving of the CCD 15 is stopped. At this time, when the camera-shake compensation OFF mode is selected, the image capturing surface of the CCD 15 is kept fixed almost at the center of the exposure area EA (from time t53 to time t54).

Changing of Flash Synchronization Speed

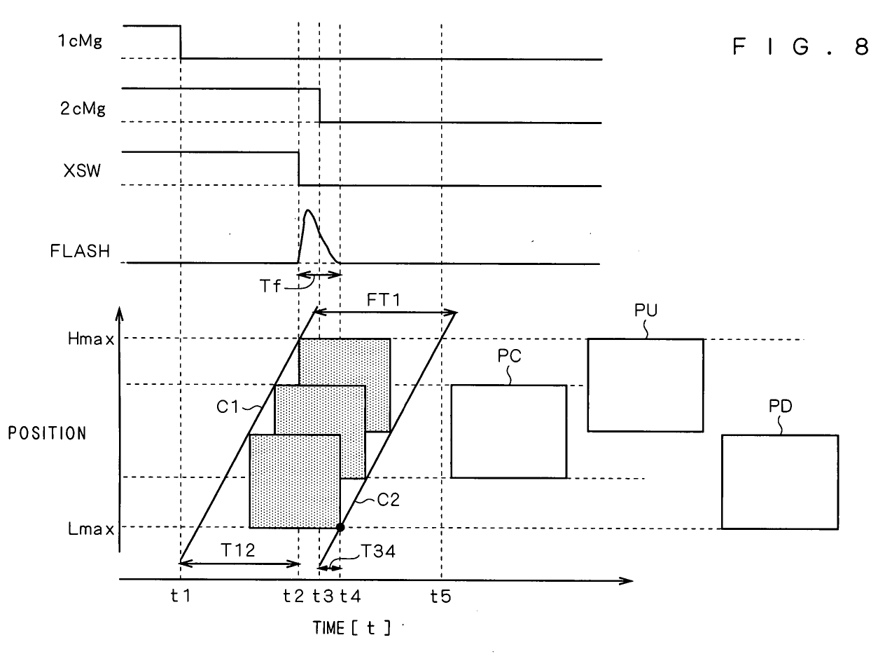

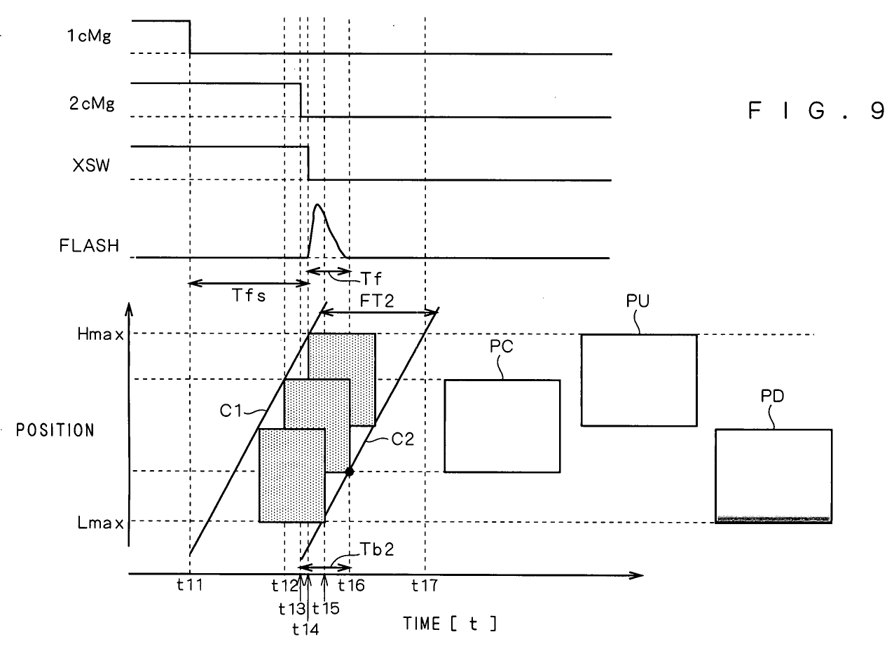

FIGS. 8 and 9 are explanatory views of flash synchronization speeds in the camera-shake compensation ON mode and camera-shake compensation OFF mode, respectively, each showing the operation of the image capturing apparatus 10a in flash shooting with the flash synchronization speed set at a value obtained by raising the shutter speed as high as possible.

FIGS. 8 and 9 each plot time (t) on the horizontal axis and indicate timing charts of the respective control signals, the flash emission state and the shutter operation, in descending order. On the right side of the timing chart of the shutter operations, the distributions of the amount of exposure are shown. More specifically, FIGS. 8 and 9 each show the timing charts of the front-curtain driving start signal (1cMg), rear-curtain driving start signal (2cMg), flash emission start signal (XSW) and flash emission state (FLASH), in descending order. Shown below these timing charts is a timing chart of changes in positional relationship of the front curtain PF and rear curtain PB with respect to the exposure area EA in the vertical direction, that is, the timing chart of shutter operations.

When the front-curtain driving start signal (1cMg), rear-curtain driving start signal (2cMg) and flash emission start signal (XSW) are changed from “H” (high) to “L” (low) state, the driving of the front curtain PF, the driving of the rear curtain PB and the flash emission are started, respectively. Referring to the flash emission state (FLASH), part of the waveform that projects upwardly corresponds to the flash intensity. Referring to the changes in positional relationship of each of the front curtain PF and rear curtain PB with respect to the exposure area EA, the upper end and lower end of an area in which the image-capturing area can be shifted (i.e., exposure area) EA are indicated by Hmax and Lmax, respectively, and changes in position of the lower end PFe of the front curtain PF and upper end PBe of the rear curtain PB are shown by solid lines C1 and C2, respectively. Further, the distributions of the amount of exposure when the image capturing apparatus 10a is driven in response to the signals and timing of operations shown in FIGS. 8 and 9 are illustrated for respective regions (upper end region PU, central region PC and lower end region PD) occupied by the image capturing surface of the imaging device assumed to be placed at the highest possible position, the center and the lowest possible position of the exposure area EA, respectively (that is, the distributions are shown lighter as the amount of exposure increases and darker as the amount of exposure decreases).

Pressing the release button 7 with either the camera-shake compensation ON mode or camera-shake compensation OFF mode selected, an image capturing operation is started. The flash synchronization speed needs to be determined considering the case in which the built-in flash 8 emits the maximum amount of light because of its performance. Accordingly, a method of determining the flash synchronization speed will be discussed referring to FIGS. 8 and 9 illustrating the case in which the built-in flash 8 emits the maximum amount of light.

First, referring to FIG. 8, a flash synchronization speed (FT1) in the camera-shake compensation ON mode will be discussed.

As shown in FIG. 8, upon start of an image capturing operation, the driving of the front curtain PF is started (at time t1), and the lower end PFe of the front curtain PF reaches the upper end Hmax of the exposure area EA (at time t2). Then, a state is brought about in which exposure can be made on the whole exposure area EA, that is, the shutter 112 is fully opened (shutter-open state). At this time, the front curtain PF mechanically works on the predetermined mechanical switch MS to bring the mechanical switch MS into an ON state. In other words, the flash emission start signal (XSW) is brought into an L state, in which flash emission is started. The timing of driving the rear curtain PB is determined by the shutter speed. In this case, however, the driving of the rear curtain PB is started (at time t3) with such timing that the upper end PBe of the rear curtain PB of the shutter 112 reaches the lower end Lmax of the exposure area EA at the end of flash emission (at time t4). Then, the upper end PBe of the rear curtain PB reaches the upper end Hmax of the exposure area EA, at which time exposure is completed (at time t5).

As described, when the camera-shake compensation ON mode is selected, the driving timing of the shutter 112 and the flash emission timing of the built-in flash 8 are controlled such that a period of the shutter-open state over which an image of the subject is formed on the whole exposure area EA (from time t2 to time t4) includes a flash emission period. Further, in order to uniformly increase the distributions of the amount of exposure by uniformly illuminating the image capturing surface with light reflected from the subject, a period over which the whole exposure area EA is illuminated needs to be set at or longer than the longest flash emission period, i.e., a flash emission period when the built-in flash 8 emits the maximum amount of flash (hereinafter also called “the maximum flash emission period”) Tf.

The flash synchronization speed FT1 in this case is expressed by the following equation (1) using a period T12 between time t1 and time t2, a period T34 between time t3 and time t4 and the maximum flash emission period Tf.
FT1=T12+Tf−T34 (1)

The driving speeds of the front curtain PF and rear curtain PB are previously determined by the design of the shutter 112, and the positional relationship of the front curtain PF and rear curtain PB with respect to an optical path leading to the image capturing surface placed almost at the center of the exposure area EA is determined by the design. Therefore, the periods T12 and T34 can previously be estimated. The maximum flash emission period Tf can previously be estimated based on the design of the built-in flash 8 and the like. As a result, the flash synchronization speed FT1 can previously be obtained from the above equation (1), and information about the flash synchronization speed FT1 is previously recorded in the ROM 76 and can be used for exposure control. For instance, in actual flash shooting, a shutter speed equal to or lower than the flash synchronization speed FT1, the aperture diameter of the diaphragm 33 and the amount of flash to be emitted from the built-in flash 8 are determined based on the exposure value under the control of the exposure control part 71. Then, the driving timing of the rear curtain PB is determined in accordance with the determined shutter speed and the driving timing of the front curtain PF. The timing of start of flash emission is the timing with which the front curtain PF mechanically works on the mechanical switch MS as described above.

Next, referring to FIG. 9, a flash synchronization speed (FT2) in the camera-shake compensation OFF mode will be discussed.

Pressing the release button 7 with the camera-shake compensation OFF mode selected, an image capturing operation is started. Then, the driving of the front curtain PF is started (at time t11) as shown in FIG. 9. Then, light reflected from a subject forms an image on the whole image capturing surface of the CCD 15 placed almost at the center of the exposure area EA (at time t12). Further, the driving timing of the rear curtain PB is determined based on the shutter speed. In this case, however, as a result, the driving of the rear curtain PB is started (at time t13) with such timing that the flash emission period (i.e., the maximum flash emission period Tf) elapses at the time (at time t16) when the upper end PBe of the rear curtain PB starts blocking the lower end of the optical path which guides light reflected from the subject to the image capturing surface of the CCD 15 placed almost at the center of the exposure area EA.

When the lower end PFe of the front curtain PF reaches the upper end Hmax of the exposure area EA (at time t14), a state is brought about in which exposure can be made on the whole exposure area EA, that is, the shutter 112 is fully opened (shutter-open state). At this time, the front curtain PF mechanically works on the predetermined mechanical switch MS, and the flash emission start signal (XSW) is brought into the L state, in which flash emission is started. Thereafter, the upper end PBe of the rear curtain PB reaches the upper end Hmax of the exposure area EA, at which time exposure is completed (at time t17).

Here, the amount of exposure is considered for each of regions (upper end region PU, central region PC and lower end region PD) occupied by the image capturing surface of the imaging device assumed to be placed at the highest possible position, the center and the lowest possible position of the exposure area EA, respectively. In the regions PC and PU, the amount of exposure is uniformly high. In the most part of the region PD, the amount of exposure is high but low near the lower end. From time t12 to time t16, the image capturing surface of the CCD 15 placed almost at the center of the exposure area EA is uniformly illuminated with light reflected from the subject. Accordingly, in the camera-shake compensation OFF mode, a period between the start of the open state of the front curtain PF and the end of an image forming state in which light reflected from the subject forms an image on the whole image capturing surface of the CCD 15 placed almost at the center of the exposure area EA may be set at the maximum flash emission period Tf or longer.

The flash synchronization speed TF2 in this case is expressed by the following equation (2) using a period Tfs between time t 11 and time t14, a period Tb2 between time t13 and time t16 and the maximum flash emission period Tf.
FT2=Tfs+Tf−Tb2 (2)

The driving speeds of the front curtain PF and rear curtain PB are previously determined by the design of the shutter 112, and the positional relationship of the front curtain PF and rear curtain PB with respect to an optical path leading to the image capturing surface placed almost at the center of the exposure area EA is determined by the design. Therefore, the periods Tfs and Tb2 can previously be estimated. The maximum flash emission period Tf can previously be estimated based on the design of the built-in flash 8 and the like. As a result, the flash synchronization speed TF2 can previously be obtained from the above equation (2), and information about the flash synchronization speed FT2 can previously be recorded in the ROM 76 to be used in exposure control. For instance, in actual flash shooting, a shutter speed equal to or lower than the flash synchronization speed FT2, the aperture diameter of the diaphragm 33 and the amount of flash to be emitted from the built-in flash 8 are determined based on the exposure value under the control of the exposure control part 71. Then, the driving timing of the rear curtain PB is determined in accordance with the shutter speed and the driving timing of the front curtain PF. The timing of start of flash emission is the timing with which the front curtain PF mechanically works on the mechanical switch MS as described above.

Further, in the case where exposure control is performed based on the flash synchronization speed FT2, the blocking of the optical path leading to the whole exposure area EA is started before the end of the maximum flash emission period Tf of the built-in flash 8 in flash shooting under the control of the overall control section 500 in a shooting condition under which the flash emission period is relatively long, such as the case in which the built-in flash 8 emits the maximum amount of light. Then, the driving of the shutter 112 and flash emission from the built-in flash 8 are controlled such that the blocking of the optical path leading to the image capturing surface of the CCD 15 placed almost at the center of the exposure area EA is started after a lapse of a predetermined period equal to or longer than the maximum flash emission period Tf (i.e., including the maximum flash emission period Tf) from the start of flash emission from the built-in flash 8.

As described above, in the camera-shake compensation ON mode, the whole exposure area EA needs to be uniformly illuminated with light reflected from the subject, whereas in the camera-shake compensation OFF mode, only the image capturing surface placed almost at the center of the exposure area EA needs to be uniformly illuminated with light reflected from the subject. Therefore, the flash synchronization speed (FT2) in the camera-shake compensation OFF mode can be set relatively higher than the flash synchronization speed (FT1) in the camera-shake compensation ON mode.

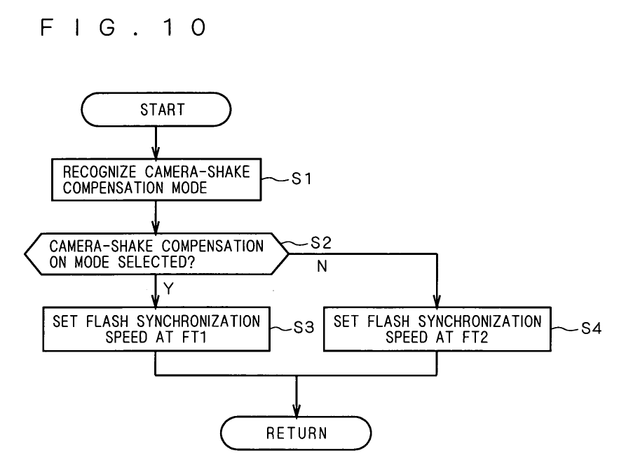

FIG. 10 is a flow chart of a changing operation of a flash synchronization speed. This flow is controlled by the overall control section 500. When the shooting mode is selected, the process proceeds into step S1 shown in FIG. 10.

In step S1, the camera-shake compensation mode selected by the mode setting dial 6 is recognized, and the process proceeds into step S2.

In step S2, it is judged whether or not the camera-shake compensation ON mode is selected. When the camera-shake compensation ON mode is selected, the process proceeds into step S3, and when the camera-shake compensation OFF mode is selected, the process proceeds into step S4.

In step S3, the flash synchronization speed is set at FT1 for the camera-shake compensation ON mode, and the process returns to step S1.

In step S4, the flash synchronization speed is set at FT2 for the camera-shake compensation OFF mode, and the process returns to step S1.

As described, in the image capturing apparatus 10a according to the first preferred embodiment, the flash synchronization speed in the camera-shake compensation OFF mode for not achieving camera-shake compensation is set relatively higher than the flash synchronization speed in the camera-shake compensation ON mode for achieving camera-shake compensation. With such setting, a higher shutter speed can be set in the camera-shake compensation OFF mode, which thus widens settable ranges of various exposure conditions such as shutter speeds and aperture values. As a result, appropriate shooting in accordance with a subject can be performed.

Further, in the camera-shake compensation OFF mode in flash shooting, the blocking of the optical path leading to the whole exposure area EA in which the image capturing surface of the CCD 15 can be shifted is started before the end of the flash emission period of the built-in flash 8 while exposure is conducted with the CCD 15 placed almost at the center of the exposure area EA. Then, the driving of the shutter 112 is controlled such that the blocking of the optical path leading to the image capturing surface of the CCD 15 placed almost at the center of the exposure area EA is started after a lapse of a predetermined period including the maximum flash emission period Tf from the start of flash emission from the built-in flash 8. With such configuration, the shutter 112 can be closed in an early stage in the camera-shake compensation OFF mode. Therefore, the flash synchronization speed can be set high without fail.

Since the flash synchronization speed in the camera-shake compensation ON mode is relatively lower than that in the camera-shake compensation OFF mode, the shutter speed can only be set at up to relatively low values in the camera-shake compensation ON mode. Generally, as the shutter speed decreases, image blur is more likely to occur due to camera shake. In the camera-shake compensation ON mode, however, the camera-shake compensation function can prevent the occurrence of image blur due to camera shake even at low shutter speeds. Accordingly, there is a high possibility that image capturing is performed without mistakes when either the camera-shake compensation ON mode or camera-shake compensation OFF mode is selected and even when the brightness of the subject falls within any numerical range.

### Second Preferred Embodiment

The above-described image capturing apparatus 10a according to the first preferred embodiment increases the flash synchronization speed by advancing as much as possible the timing of driving the rear curtain PB in the camera-shake compensation OFF mode. An image capturing apparatus 10b according to a second preferred embodiment is capable of increasing the flash synchronization speed further by advancing the timing of start of flash emission from the built-in flash 8 with respect to the driving of the shutter 112. The image capturing apparatus 10b according to the present embodiment and the image capturing apparatus 10a according to the first preferred embodiment differ from each other only in the method of increasing the flash synchronization speed and the use of electrical contacts for starting flash emission from the built-in flash 8. Other configuration and the like are similar to each other.

Hereinafter, the same components are indicated by the same reference characters, and explanation thereof is omitted here. The image capturing apparatus 10b according to the second preferred embodiment will be described below.

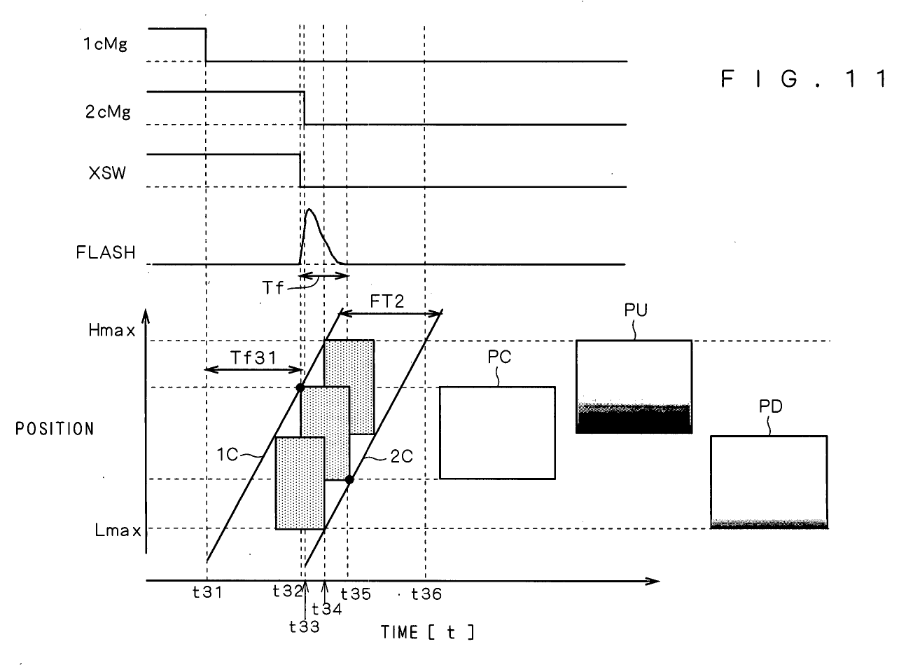

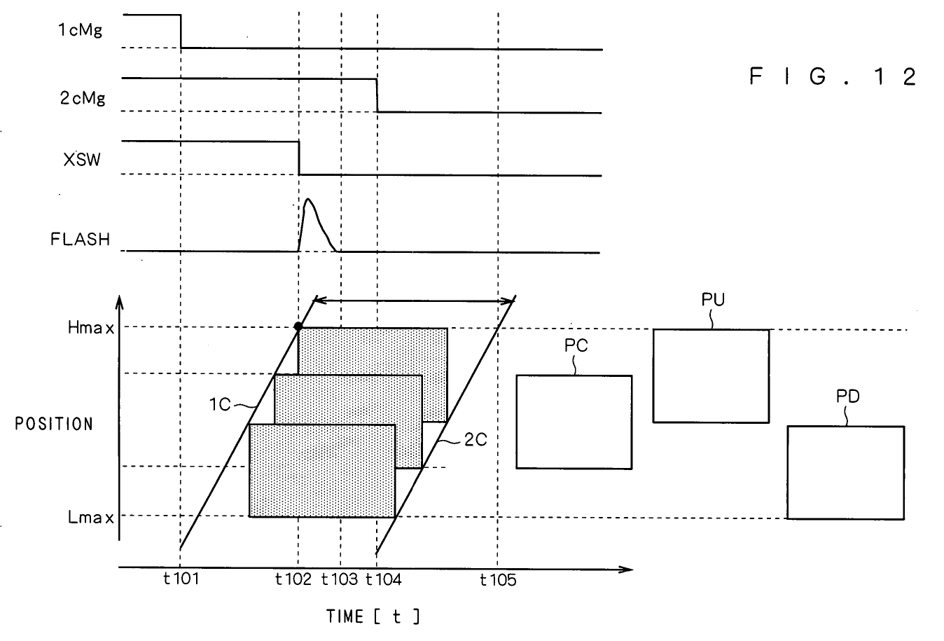

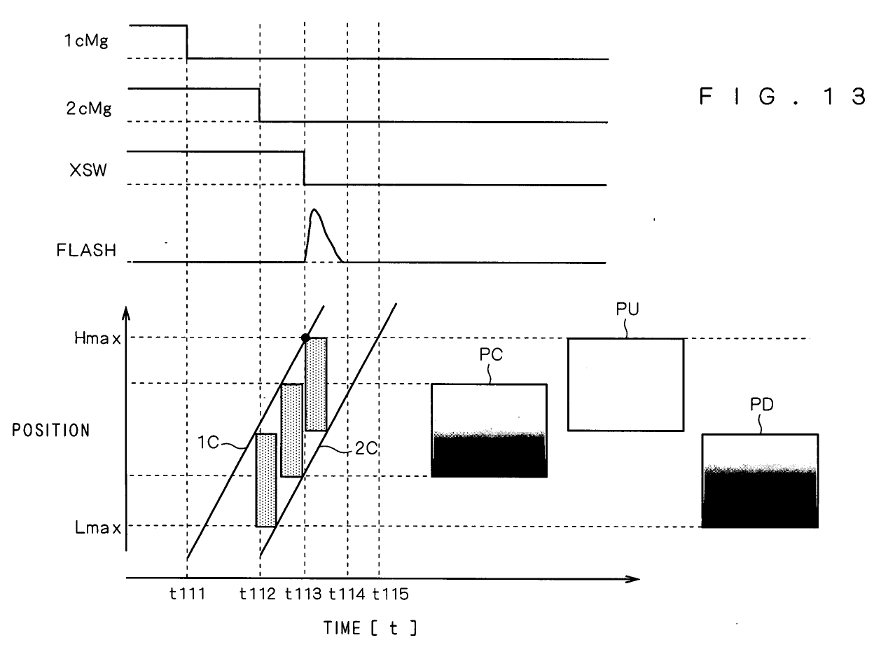

FIG. 11 is an explanatory view of a flash synchronization speed in the camera-shake compensation OFF mode. FIG. 11 shows operations of the image capturing apparatus 10b in flash shooting with the shutter speed set at the flash synchronization speed. Further, similarly to FIG. 9, FIG. 11 plots time (t) on the horizontal axis and shows timing charts of various control signals, flash emission state and shutter operations in descending order. The distributions of the amount of exposure are shown on the right side of the timing chart of shutter operations. The flash synchronization speed in the camera-shake compensation ON mode is the same as described in the first preferred embodiment, description of which is thus omitted here. Hereafter, referring to FIG. 11, the flash synchronization speed in the camera-shake compensation OFF mode will be discussed now.

Pressing the release button 7 with the camera-shake compensation OFF mode selected, an image capturing operation is started. Then, the driving of the front curtain PF is started as shown in FIG. 11 (at time t31). Then, light reflected from a subject forms an image on the whole image capturing surface of the CCD 15 placed almost at the center of the exposure area EA (at time t32). At this time, for instance, the overall control section 500 transmits a signal to electrical contacts constructed from transistors and the like provided in the flash circuit 441, and the flash emission start signal (XSW) is brought into the L state, in which flash emission is started.

Further, the driving timing of the rear curain PB is determined based on the shutter speed. Here, as a result, the driving of the rear curtain PB is started (at time t33) with such timing that the flash emission period (i.e., the maximum flash emission period Tf) elapses at the time (at time t35) when the upper end PBe of the rear curtain PB starts blocking the lower end of the optical path which guides light reflected from the subject to the image capturing surface of the CCD 15 placed almost at the center of the exposure area EA.

When the lower end PFe of the front curtain PF reaches the upper end Hmax of the exposure area EA (at time t34), a state is brought about in which exposure can be made on the whole exposure area EA, that is, the shutter 112 is fully opened (shutter-open state). Thereafter, the rear curtain PB is driven until the upper end PBe reaches the upper end Hmax of the exposure area EA, at which time exposure is completed (at time t36).

Here, the amount of exposure is considered for each of regions (upper end region PU, central region PC and lower end region PD) occupied by the image capturing surface of the imaging device assumed to be placed at the highest possible position, the center and the lowest possible position of the exposure area EA, respectively. In the region PC, the amount of exposure is uniformly high. In the region PU, the amount of exposure is high in the upper portion but low in the lower portion. In the region PD, the amount of exposure is high in the most part but low near the lower end.

The flash synchronization speed FT2 in this case is expressed by the following equation (3) using a period Tf31 between time t31 and time t32, a period Tfb3 between time t33 and time t35 and the maximum flash emission period Tf.
FT2=Tf31+Tf−Tfb3 (3)

The driving speeds of the front curtain PF and rear curtain PB are previously determined by the design of the shutter 112, and the positional relationship of the front curtain PF and rear curtain PB with respect to an optical path leading to the image capturing surface of the CCD 15 placed almost at the center of the exposure area EA is determined by the design. Therefore, the periods Tf31 and Tfb3 can previously be estimated. The maximum flash emission period Tf can previously be estimated based on the design of the built-in flash 8 and the like. As a result, the flash synchronization speed FT2 can previously be obtained from the above equation (3), and information about the flash synchronization speed FT2 can previously be recorded in the ROM 76 to be used in exposure control.

For instance, in actual flash shooting, a shutter speed equal to or lower than the flash synchronization speed FT2, the aperture diameter of the diaphragm 33 and the amount of light to be emitted from the built-in flash 8 are determined based on the exposure value under the control of the exposure control part 71. Then, the driving timing of the rear curtain PB is determined in accordance with the shutter speed and the driving timing of the front curtain PF. Flash emission from the built-in flash 8 can be started by transmitting a signal to the electrical contacts after a lapse of the period Tf31 from the start of the driving of the front curtain PF based on information previously stored in the ROM 76.

That is, in flash shooting, the flash emission period of the built-in flash 8 is started under the control of the overall control section 500 after a lapse of a predetermined period (in this case, period Tf31) between the start of opening of an optical path by the front curtain PF and the end of opening of an optical path leading to the image capturing surface of the CCD 15 placed almost at the center of the exposure area EA, and before the end of opening of an optical path leading to the whole exposure area EA. With such settings, the flash synchronization speed is higher than in the camera-shake compensation ON mode in which flash emission is started after the end of opening of the optical path leading to the whole exposure area EA.

The flow of the changing operation of the flash synchronization speed according to the second preferred embodiment is the same as that shown in FIG. 10 referred to in the first preferred embodiment.

As described, in the image capturing apparatus 10b according to the second preferred embodiment, exposure is made with the CCD 15 placed in a predetermined position (in this case, almost at the center of the exposure area EA) in the case where camera-shake compensation is not conducted in flash shooting. At this time, flash emission from the built-in flash 8 is started after a lapse of a predetermined period (including the period Tf31) from the start of opening of the front curtain PF of the shutter 112 and before the end of opening of the optical path leading to the whole exposure area EA where the image capturing surface of the CCD 15 can be shifted. More specifically, flash emission from the built-in flash 8 is started after a lapse of a period between the start of opening of the shutter 112 and the end of opening of the optical path leading to the image capturing surface of the CCD 15 placed almost at the center of the exposure area EA and before the end of opening of the optical path leading to the whole exposure area EA. With such settings, flash emission can be started at an early stage in the camera-shake compensation OFF mode for not achieving camera-shake compensation. The flash synchronization speed can thereby be set high.

Variant

Although the preferred embodiments of the present invention have been described above, the present invention is not limited to the above descriptions.

For instance, the above preferred embodiments achieve camera-shake compensation by shifting the CCD 15 relative to the housing 1a of the image capturing apparatus 10a, 10b, however, the present invention is not limited as such, but may be configured to achieve camera-shake compensation by moving the plurality of lens elements included in the interchangeable lens device 2 vertically and horizontally as appropriate.

Further, the above preferred embodiments describe flash shooting using the built-in flash 8, however, the present invention is also applicable to an image capturing apparatus using a flash (external flash) attached to the image capturing apparatus from outside or provided outside the image capturing apparatus connected such that signal transmission is available.

Furthermore, the above preferred embodiments each illustrate a digital camera as an example of an image capturing apparatus, however, the present invention is not limited as such, but is also applicable to, for example, various image capturing apparatuses such as a single lens reflex camera using a silver halide film or the like.

Still further, the above preferred embodiments describe capturing of a still image, however, the present invention is not limited as such, but is also applicable to, for example, capturing of respective images constituting a motion image.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
a taking lens device for forming a light image of a subject on a predetermined image capturing surface;
a light emitter for emitting light in flash shooting;
a camera-shake compensation part for suppressing a relative displacement between said image capturing surface and said light image caused by camera shake, thereby achieving camera-shake compensation;
a mode setting part for selecting between a first mode in which said camera-shake compensation part is activated and a second mode in which said camera-shake compensation part is deactivated; and
a changing part for changing a flash synchronization speed in accordance with a selection made by said mode setting part.

2. The image capturing apparatus according to claim 1, wherein
said changing part changes a flash synchronization speed so as to be higher in said second mode than in said first mode.

3. The image capturing apparatus according to claim 1, wherein
said image capturing surface is disposed on an imaging device provided for said image capturing apparatus, and
said camera-shake compensation part shifts said image capturing surface relative to said image capturing apparatus, thereby achieving camera-shake compensation.

4. The image capturing apparatus according to claim 1, wherein
said second mode is a mode for performing exposure with said image capturing surface placed in a predetermined position,
said image capturing apparatus further comprising:
a shutter mechanism for blocking an optical path which guides light reflected from said subject to said image capturing surface; and
a controller for controlling said shutter mechanism and said light emitter such that blocking of an optical path leading to a whole of a predetermined area in which said image capturing surface can be shifted is started before the end of a period of a light emission from said light emitter and such that blocking of an optical path leading to said image capturing surface placed in said predetermined position is started after a lapse of a predetermined time from a start of said light emission, when said second mode is selected in flash shooting.

5. The image capturing apparatus according to claim 4, wherein
said predetermined time includes said period of said light emission.

6. The image capturing apparatus according to claim 1, wherein
said second mode is a mode for performing exposure with said image capturing surface placed in a predetermined position,
said image capturing apparatus further comprising:
a shutter mechanism for blocking an optical path which guides light reflected from said subject to said image capturing surface; and
a controller for controlling said shutter mechanism and said light emitter such that light emission from said light emitter is started after a lapse of a predetermined time from a start of opening of said optical path performed by said shutter mechanism and before the end of opening of an optical path leading to a whole of a predetermined area in which said image capturing surface can be shifted, when said second mode is selected in flash shooting.

7. The image capturing apparatus according to claim 6, wherein
said predetermined time is a period between a start of opening of said shutter mechanism and the end of opening of an optical path leading to said image capturing surface placed in said predetermined position.

8. An image capturing apparatus comprising:
a taking lens device for forming a light image of a subject on a predetermined image capturing surface;
a light emitter for emitting light in flash shooting;
a camera-shake compensation part for suppressing a relative displacement between said image capturing surface and said light image caused by camera shake, thereby achieving camera-shake compensation; and
a mode setting part for selecting between a first mode in which said camera-shake compensation part is activated and a second mode in which said camera-shake compensation part is deactivated, wherein
a flash synchronization speed is set higher in said second mode than in said first mode.

9. The image capturing apparatus according to claim 8, wherein
said image capturing surface is disposed on an imaging device provided for said image capturing apparatus, and
said camera-shake compensation part shifts said image capturing surface relative to said image capturing apparatus, thereby achieving camera-shake compensation.

10. The image capturing apparatus according to claim 8, wherein
said second mode is a mode for performing exposure with said image capturing surface placed in a predetermined position,
said image capturing apparatus further comprising:
a shutter mechanism for blocking an optical path which guides light reflected from said subject to said image capturing surface; and
a controller for controlling said shutter mechanism and said light emitter such that blocking of an optical path leading to a whole of a predetermined area in which said image capturing surface can be shifted is started before the end of a period of a light emission from said light emitter and such that blocking of an optical path leading to said image capturing surface placed in said predetermined position is started after a lapse of a predetermined time from a start of said light emission, when said second mode is selected in flash shooting.

11. The image capturing apparatus according to claim 10, wherein
said predetermined time includes said period of said light emission.

12. The image capturing apparatus according to claim 8, wherein
said second mode is a mode for performing exposure with said image capturing surface placed in a predetermined position,
said image capturing apparatus further comprising:
a shutter mechanism for blocking an optical path which guides light reflected from said subject to said image capturing surface; and
a controller for controlling said shutter mechanism and said light emitter such that light emission from said light emitter is started after a lapse of a predetermined time from a start of opening of said optical path performed by said shutter mechanism and before the end of opening of an optical path leading to a whole of a predetermined area in which said image capturing surface can be shifted, when said second mode is selected in flash shooting.

13. The image capturing apparatus according to claim 12, wherein
said predetermined time is a period between a start of opening of said shutter mechanism and the end of opening of an optical path leading to said image capturing surface placed in said predetermined position.

14. A method of setting a flash synchronization speed in an image capturing apparatus, comprising the steps of:
(a) selecting between a first mode of suppressing a relative displacement between an image capturing surface and a light image of a subject formed on said image capturing surface caused by camera shake for achieving camera-shake compensation and a second mode for not achieving said camera-shake compensation; and
(b) setting a flash synchronization speed relatively higher than in said first mode when said second mode is selected in said step (a).
